(19) United States
(12) Patent Application Publication
(10) Pub. No.: US 2019/0376545 A1
(43) Pub. Date: Dec. 12, 2019

(54) T-SLOT CONNECTION INSERT APPARATUSES AND METHODS OF MAKING AND USING THE SAME

(71) Applicant: Clayton Vowels, Crystal Lake, IL (US)

(72) Inventor: Clayton Vowels, Crystal Lake, IL (US)

(21) Appl. No.: 16/434,805

(22) Filed: Jun. 7, 2019

Related U.S. Application Data
(60) Provisional application No. 62/682,211, filed on Jun. 8, 2018.

(51) Int. Cl. F16B 9/00

(52) U.S. Cl. CPC F16B 9/054; F16B 2200/10

(57) ABSTRACT

T-slot connection insert apparatuses comprise a first connector tab having a first connection aperture therein and a second connector tab having a second connection aperture therein, wherein the first connector tab and the second connector tab are connected together via a bridging span.

The present invention claims priority to U.S. Prov. Pat. App. No. 62/682,211, titled “T-Slot Connection Insert Apparatuses and Methods of Making and Using the Same,” filed Jun. 8, 2018, which is incorporated by reference herein in its entirety.

### TECHNICAL FIELD

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

### BACKGROUND

T-slot aluminum frame pieces are used to provide modular frames having connection points therein at necessary and desired locations. The frame pieces are typically connected together to form a frame on which various components are attached. FIG. 1 illustrates a prior art T-slot frame piece. For example, a T-slot aluminum frame may be constructed using the modular T-slot aluminum frame pieces, and a component such as a piece of equipment may be attached thereto. FIG. 2 illustrates an exemplary prior art T-slot frame that may be constructed from T-slot frame pieces. Connectors, typically including a short tab of material, such as plastic, metal or other like material, are disposed within so-called “T-slots” within one or more of the surfaces of the T-slot aluminum frame pieces. FIG. 3 illustrates a plurality of typical prior art connectors that may be disposed within the T-slots of the frame pieces. The connectors typically include a single aperture within which is a thread for holding a bolt that may extend from a piece of equipment, and allow the piece of equipment to be bolted to the frame. FIG. 4 illustrates an example of a prior art connector disposed within a T-slot of a frame piece.

The connectors may be disposed within the slots of the T-slot frame pieces in any desired location, making the T-slot aluminum frame pieces desirable by users thereof. Thus, users may build modular frames from the T-slot aluminum frame pieces and position the connectors in the desired locations to easily bolt equipment thereto in particular locations on the frame. FIG. 5 illustrates a motor mounted to a T-slot frame. As illustrated the motor is bolted into a plurality of connectors within T-slots of the frame pieces in an illustration of prior art.

However, as useful as the T-slot frame pieces and connectors are, it is often difficult to align the connectors in position to accept bolts from equipment. Indeed, oftentimes equipment requires two or more connection points to securely connect the equipment to the T-slot frames. Although it may be somewhat easy to align a single connector with a single bolt on a piece of equipment, once the equipment is attached to one connector, aligning a second connector with a second bolt on the piece of equipment can be very difficult. This is so because the piece of equipment itself may interfere with a user's ability to reach and align the connector as desired.

Oftentimes, typical connectors slide freely within T-slots and as such become difficult to align with bolts on equipment. A slight bump to the frame may cause the connector to misalign, and a user may not realize it until he or she attempts to connect a bolt thereto. Once a misalignment is detected, the user may have to remove the equipment and reset the connector within the T-slot.

Moreover, because each connector is independently alignable within the T-slots of the frame, each individual connector may move independently of other connectors. If a connector moves while the user is attempting to connect the bolt from the piece of equipment thereto, then it may be very difficult if not impossible to make the proper connection.

A need, therefore, exists for improved T-slot connector apparatuses. Specifically, a need exists for improved T-slot connector apparatuses that allow for easier connection of equipment to T-slot frames.

Moreover, a need exists for improved T-slot connector apparatuses that more easily and efficiently align T-slot connectors with equipment that may be attached to T-slot frames. More specifically, a need exists for improved T-slot connector apparatuses that align a plurality of connectors together at the same time, thereby allowing connectors to align and connect quickly and easily.

In addition, a need exists for improved T-slot connectors that are slidable within T-slots but may hold their position better when in a desired position. More specifically, a need exists for improved T-slot connectors that align and hold a plurality of apertures in place within a T-slot to connect a plurality of bolts thereto so that equipment may be connected more easily thereto.

### SUMMARY OF THE INVENTION

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

To this end, in an embodiment of the present invention, a T-slot connection insert apparatus is provided. The T-slot connection insert apparatus comprises a first tab comprising a first threaded aperture on a front surface therein and a second tab comprising a second threaded aperture on a front surface therein, and a bridging span between the first tab and the second tab, wherein the bridging span is connected to the first tab via a first connection pin and the second tab is connected to the bridging span via a second connection pin. In an embodiment, the first and second connection pins comprise spring-loaded ball plungers on rear surfaces therein.

It is, therefore, an advantage and objective of the present invention to provide improved T-slot connector apparatuses.

Specifically, it is an advantage and objective of the present invention to provide improved T-slot connector apparatuses that allow for easier connection of equipment to T-slot frames.

Moreover, it is an advantage and objective of the present invention to provide improved T-slot connector apparatuses that more easily and efficiently align T-slot connectors with equipment that may be attached to T-slot frames.

More specifically, it is an advantage and objective of the present invention to provide improved T-slot connector apparatuses that align a plurality of connectors together at the same time, thereby allowing connectors to align and connect quickly and easily.

In addition, it is an advantage and objective of the present invention to provide improved T-slot connectors that are slidable within T-slots but may hold their position better when in a desired position.

More specifically, it is an advantage and objective of the present invention to provide improved T-slot connectors that align and hold a plurality of apertures in place within a T-slot to connect a plurality of bolts thereto so that equipment may be connected more easily thereto.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art T-Slot frame piece.

FIG. 2 illustrates a prior art T-slot frame.

FIG. 3 illustrates prior art T-slot connector nuts.

FIG. 4 illustrates a prior art T-slot connector nut disposed within a T-slot on a frame piece.

FIG. 5 illustrates a prior art piece of equipment, namely a motor, mounted to a T-slot frame piece via T-slot connector nuts.

FIG. 6 illustrates a front side of a T-slot connection insert apparatus in an embodiment of the present invention.

FIG. 7 illustrates a rear side of a T-slot connection insert apparatus in an embodiment of the present invention.

FIG. 8 illustrates a T-slot framing piece comprising a T-slot connection insert apparatus disposed within a T-slot thereof in an embodiment of the present invention.

FIG. 9 illustrates a prior art mounting bracket.

FIG. 10 illustrate a prior art mounting bracket connected to a T-slot connection insert apparatus disposed within a T-slot of a T-slot framing piece.

FIG. 11 illustrates a T-slot connection insert apparatus in an alternate embodiment of the present invention.

FIG. 12 illustrates a T-slot connection insert apparatus in an alternate embodiment of the present invention.

FIG. 13 illustrates a side profile view of a T-slot connection insert apparatus in an alternate embodiment of the present invention.

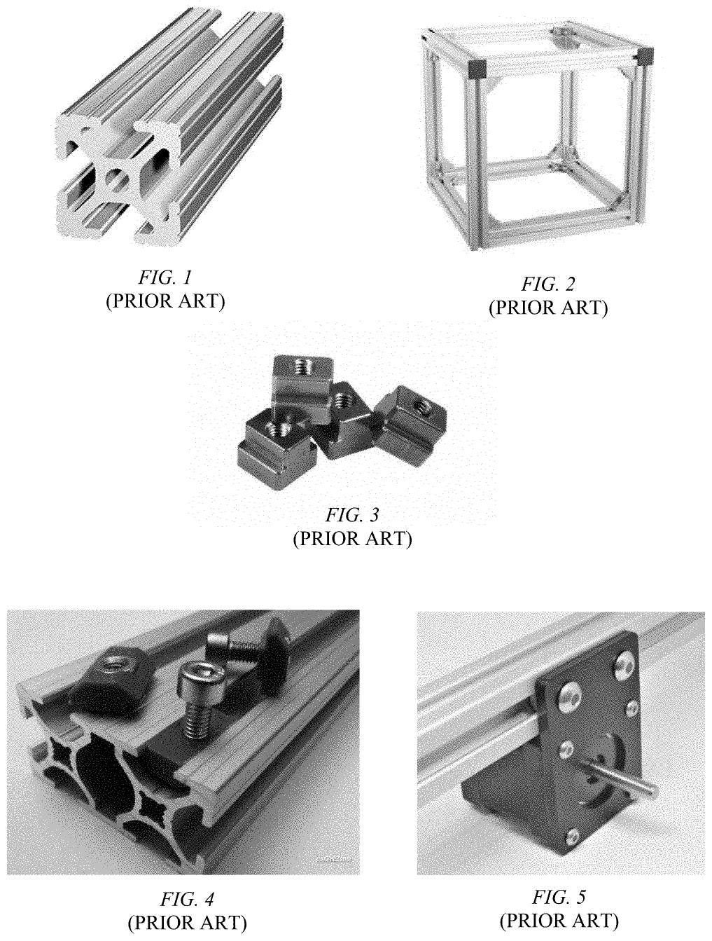

### DETAILED DESCRIPTION OF THE PRESENTLY PREFERRED EMBODIMENTS

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

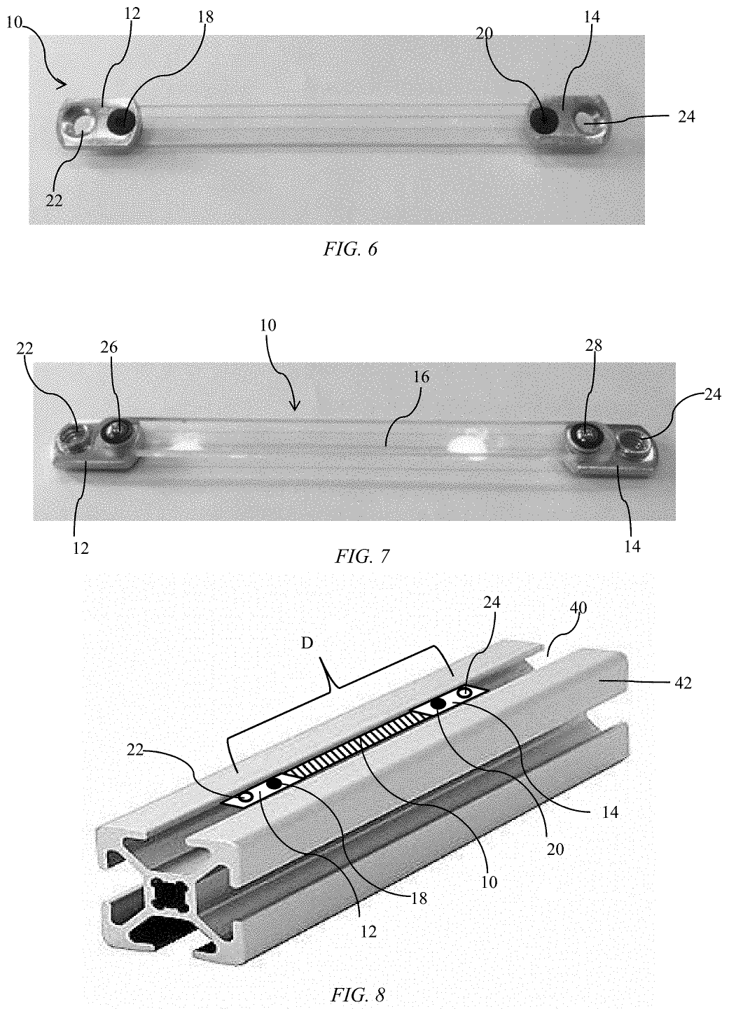

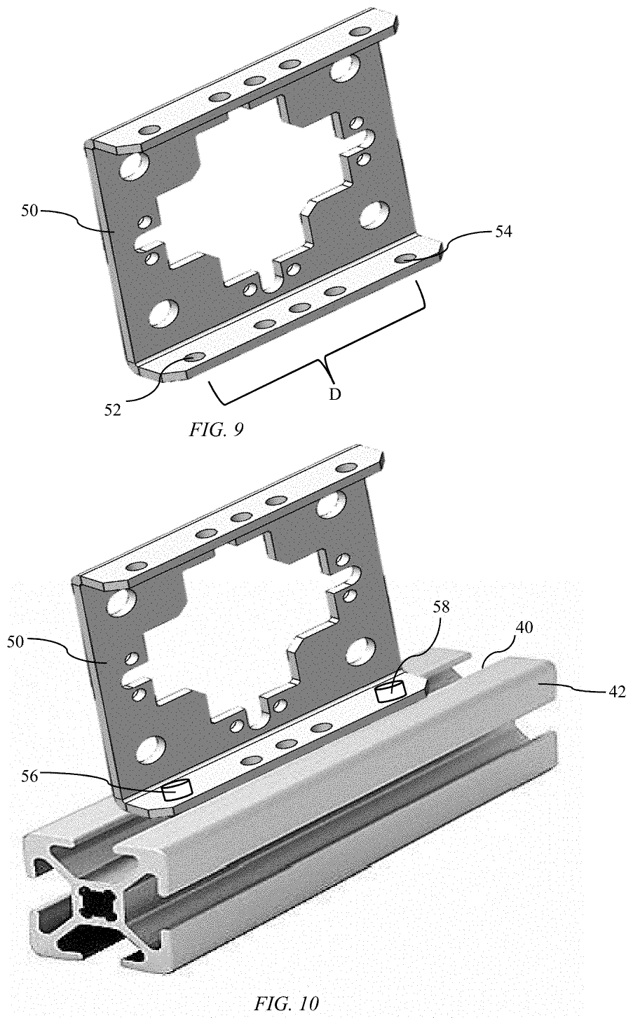

Now referring to the figures, wherein like numerals refer to like parts, a T-slot connection insert apparatus 10 is illustrated in FIG. 6. The T-slot connection insert apparatus comprises a first tab 12 and a second tab 14 connected on opposite ends of a bridging span 16 via first and second connectors 18, 20, respectively. As illustrated, a first threaded aperture 22 may be disposed within the first tab 12 and a second threaded aperture 24 may be disposed in the second tab 14. The first and second threaded apertures may receive threaded bolts for holding attachable items in place on a T-slot frame piece when disposed within a T-slot thereof, as illustrated in FIGS. 8 and 9.

The first tab 12 and the second tab 14 may be made from metal, plastic, composite materials, or any other material apparent to one of ordinary skill in the art. The first and second connectors 18, 20 may be disposed through the first and second tabs 12, 14 and hold the first and second tabs 12, 14 to opposite ends of the bridging span 16. Likewise, the bridging span 16 may be made from any material, such as metal, plastic, composite materials or the like, as apparent to one of ordinary skill in the art.

FIG. 7 illustrates a bottom view of the T-slot connection insert apparatus 10. On a bottom surface of the first and second tabs 12, 14, respectively, may be first and second spring-loaded ball plungers 26, 28 that may be held in place and spring back when pressed. The ball plungers may provide tension against a bottom of a T-slot in which the T-slot connection insert apparatus 10 is placed.

When disposed within a T-slot 40 of a T-slot framing piece 42, as illustrated in FIG. 8, the T-slot connection insert apparatus 10 holds the tabs 12, 14 apart from each other so that the first and second threaded apertures 22, 24 are held in place a distance “D” from one another. By holding the first and second tabs 12, 14 apart from each other so that the first and second threaded apertures 22, 24 are held in place a distance “D” from each other, a workpiece may be connected thereto having connection apertures that match the distance “D” so that the workpiece may be connected to the T-slot connection insert apparatus 10 and, more specifically, the first and second threaded apertures 22, 24 disposed within first and second tabs 12, 14 thereof.

Specifically, FIG. 9 illustrates a workpiece 50 that may be utilized with the present invention. More specifically, workpiece 50 may be a mount for mounting a piece of equipment, such as a motor mount or other like mount for mounting equipment thereto. The workpiece 50 may have a first connection aperture 52 and a second connection aperture 54 that are set the distance “D” apart from one another. Thus, workpiece 50 may be held to the T-slot framing piece 42 via connection to the T-slot connection insert apparatus 10 by bolts 56, 58, respectively, through first and second connection apertures 52, 54 and into first and second threaded apertures 22, 24 within first and second tabs 12, 14, respectively of the T-slot connection insert apparatus 10.

Therefore, workpiece 50 may be easily connected to the first and second tabs 12, 14 because the first and second tabs 12, 14 are held in place via bridging span 16. A user need not attempt to align both the first tab 12 and the second tab 14 independently of one another, and may have the first and second threaded apertures 22, 24 perfectly aligned with each other within the T-slot 40 of the framing piece 42.

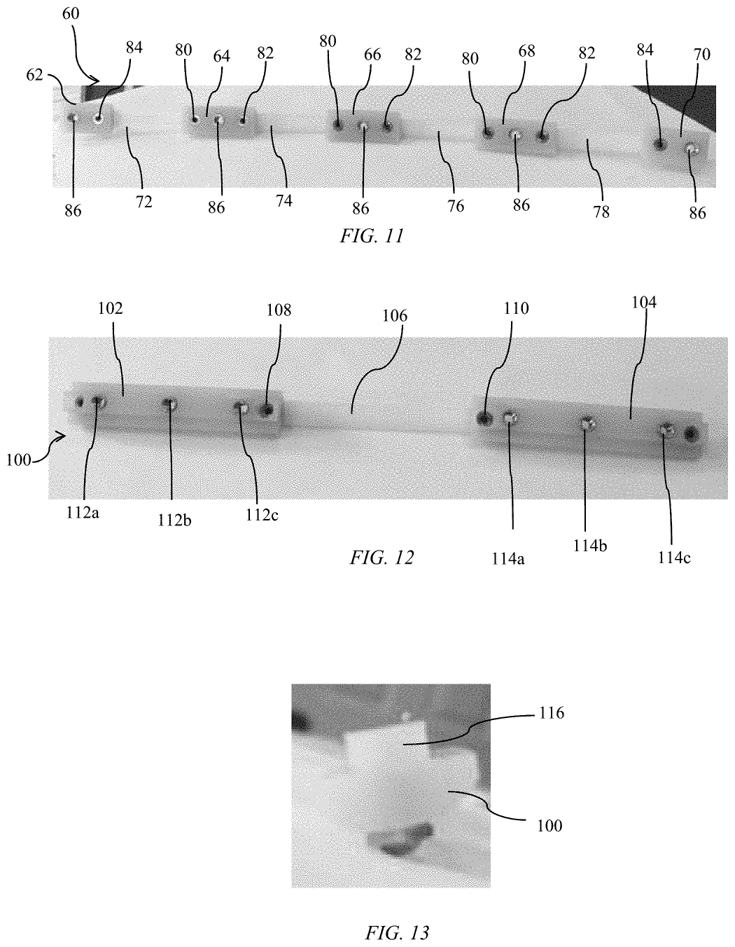

FIG. 11 illustrates a T-slot connection insert apparatus 60 in an alternate embodiment of the present invention. The T-slot connection insert apparatus 60 may have a plurality of tabs 62, 64, 66, 68 and 70, connected in series via a plurality of bridging spans 72, 74, 76, 78 disposed therebetween. Specifically, bridging span 72 may span between first and second tabs 62, 64, respectively; bridging span 74 may span between second and third tabs 64, 66, respectively; bridging span 76 may span between third and fourth tabs 66, 68, respectively; and bridging span 78 may span between fourth and fifth tabs 68, 70, respectively.

Second, third and fourth tabs 64, 66, 68, respectively, may have first and second connectors 80, 82 therein for connecting to respective bridging spans, and thus may be connected to the respective bridging spans at two locations on the second, third and fourth tabs 64, 66, 68, respectively. First tab 62 and fifth tab 70 may be end tabs, only have 1 connector 84 therein for connecting to a respective bridging span. Each of the tabs 62, 64, 66, 68, 70 may have a threaded aperture 86 therein for connecting a workpiece thereto. In addition, although not shown in FIG. 11, a plurality of ball plungers may be disposed on a bottom surface thereof to allow the T-slot connection insert apparatus 60 to be removably held in place within a T-slot of a T-slot framing piece.

Thus, the tabs and bridging spans may operate together to provide discrete connection points as needed for the workpiece. To accomplish this, the bridging spans 72, 74, 76, 78 may be of various lengths as needed to provide the threaded apertures in desired locations within a T-slot of a T-slot framing piece to connect to the workpiece.

FIG. 12 illustrates an alternate embodiment of the present invention of a T-slot connection insert apparatus 100 comprising a first tab 102 and a second tab 104 held in place relative to each other via bridging span 106. Connectors 108, 110 may connect the first and second tabs 102, 104 to opposite ends of the bridging span 106. Instead of a single threaded aperture in each of the first and second tabs 102, 104, there may be a plurality of threaded apertures 112a, 112b, 112c and 114a, 114b, 114c, disposed in the first and second tabs 102, 104. The plurality of threaded apertures 112a, 112b, 112c, 114a, 114b, 114c may provide many possibilities for connecting workpieces thereto. As noted above, a plurality of ball plungers (not shown) may extend from the T-slot connection insert apparatus 100 to hold the T-slot connection insert apparatus 100 in place within a T-slot of a framing piece.

FIG. 13 illustrates a side view of the T-slot connection insert apparatus 100, illustrating an extended platform 116 that may extend from the T-slot connection insert apparatus 100 to allow the T-slot connection insert apparatus 100 to provide a surface flush or nearly flush with the surface of a T-slot framing piece. The extended platform 116 may be any height, and may therefore make it easier to connect various workpieces to the threaded apertures therein.

In an embodiment of the present invention, a user may be provided the various pieces, and may construct a T-slot connection insert apparatus that is sized properly to fit connection apertures within a workpiece, as desired. The bridging span connecting first and second tabs may be cut to size to ensure that the threaded apertures within the first and second tabs precisely line up with connection apertures within the workpieces, as needed.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A T-slot connection insert apparatus comprising:
a first tab comprising a first threaded aperture on a front surface therein;
a second tab comprising a second threaded aperture on a front surface therein;
and a bridging span between the first tab and the second tab, wherein the bridging span is connected to the first tab via a first connection pin and the second tab is connected to the bridging span via a second connection pin.

2. The T-slot connection insert apparatus of claim 1 wherein the first and second connection pins comprise spring-loaded ball plungers on rear surfaces therein.
